(19) United States
(12) Patent Application Publication
(10) Pub. No.: US 2015/0084858 A1
(43) Pub. Date: Mar. 26, 2015

(54) DISPLAY DEVICE, CONTENT DISPLAY METHOD, AND A NON-TRANSITORY COMPUTER-READABLE STORAGE MEDIUM

(71) Applicant: CASIO COMPUTER CO., LTD., Tokyo (JP)

(72) Inventors: Tomohiko MURAKAMI, Tokyo (JP); Kouichi NAKAGOME, Tokorozawa-shi (JP); Yuichi MIYAMOTO, Tokyo (JP)

(73) Assignee: CASIO COMPUTER CO., LTD., Tokyo (JP)

(21) Appl. No.: 14/490,318

(22) Filed: Sep. 18, 2014

(30) Foreign Application Priority Data
Sep. 26, 2013 (JP) 2013-199184

(51) Int. Cl. G06Q 30/02; G09G 5/00; G06K 9/00

(52) U.S. Cl. CPC G06Q 30/0255; G06K 9/00315; G09G 5/003; G09G 2320/10
USPC 345/156

(57) ABSTRACT

A display device includes: a display unit configured to display an image; a display control unit configured to switch among a plurality of kinds of content to be displayed on the display unit; and a content evaluation unit configured to evaluate an affirmation level of content displayed on the display unit, wherein the display control unit determines content to be displayed on the display unit based on the affirmation level.

### BACKGROUND

1. Technical Field

The present invention relates to a display device, a content display method, and a non-transitory computer-readable storage medium.

2. Related Art

Recently, a digital signage has been known as a tool for advertisements for general public viewers in a public place such as a store or a station. The digital signage is configured to readily change the contents of advertisements. Therefore, latest information or the like is quickly provided for the viewers, and an excellent effect of advertisement is provided, compared with a conventional sign (e.g. JP 2011-150221 A, JP 2012-128210 A).

### SUMMARY

However, advertisement display on a conventional digital signage unfortunately provides one-way advertisements in which predetermined advertisements are displayed in a cycle, and the advertisements are unlikely to have an effect for viewers who are not interested in the advertisements.

A purpose of the present invention is to provide an increased advertising effect by reflecting the interest of the viewers.

To solve the above-mentioned problem, according to a first aspect of the present invention, a display device includes a display unit, a display control unit, and a content evaluation unit. The display unit displays an image. The display control unit switches among a plurality of kinds of content and displays the switched content on the display unit. The content evaluation unit evaluates an affirmation level with respect to the content displayed on the display unit. The display control unit determines the content displayed on the display unit based on the affirmation level by the content evaluation unit.

According to an embodiment of the present invention, an advertising effect is further increased reflecting the interest of the viewers.

### BRIEF DESCRIPTION OF THE DRAWINGS

FIG. 1 is a block diagram illustrating a schematic configuration of a display system according to a first embodiment;

FIG. 2 is a block diagram illustrating a functional configuration of a digital signage;

FIG. 3 is a front view illustrating a schematic configuration of a screen unit of the digital signage;

FIG. 4 is a block diagram illustrating a functional configuration of a control unit of the digital signage;

FIG. 5 is a flowchart describing display control processing according to the first embodiment;

FIG. 6 is a flowchart describing affirmation-level calculation processing;

FIG. 7A is a view illustrating an exemplary advertisement displayed on a display unit;

FIG. 7B is a view illustrating an exemplary advertisement displayed on the display unit;

FIG. 7C is a view illustrating an exemplary advertisement displayed on the display unit;

FIG. 7D is a view illustrating an exemplary advertisement displayed on the display unit;

FIG. 8 is a flowchart describing display control processing according to a second embodiment;

FIG. 9 is a flowchart describing an order of displaying advertisements;

FIG. 10 is a flowchart describing an order of displaying advertisements;

FIG. 11A is a view illustrating an exemplary advertisement displayed on the display unit;

FIG. 11B is a view illustrating an exemplary advertisement displayed on the display unit;

FIG. 11C is a view illustrating an exemplary advertisement displayed on the display unit;

FIG. 11D is a view illustrating an exemplary advertisement displayed on the display unit;

FIG. 12 is a flowchart describing display control processing according to a third embodiment;

FIG. 13 is a flowchart describing an order of displaying advertisements;

FIG. 14 is a flowchart describing display control processing according to a fourth embodiment; and

FIG. 15 is a view illustrating an exemplary advertisement displayed on the display unit.

### DETAILED DESCRIPTION

The best mode for carrying out the present invention will be described below using the drawings. It is noted that various limitations technically preferable are assigned to the following embodiments to carry out the present invention, but the scope of the present invention is not limited to the following embodiments and exemplary illustrations.

### First Embodiment

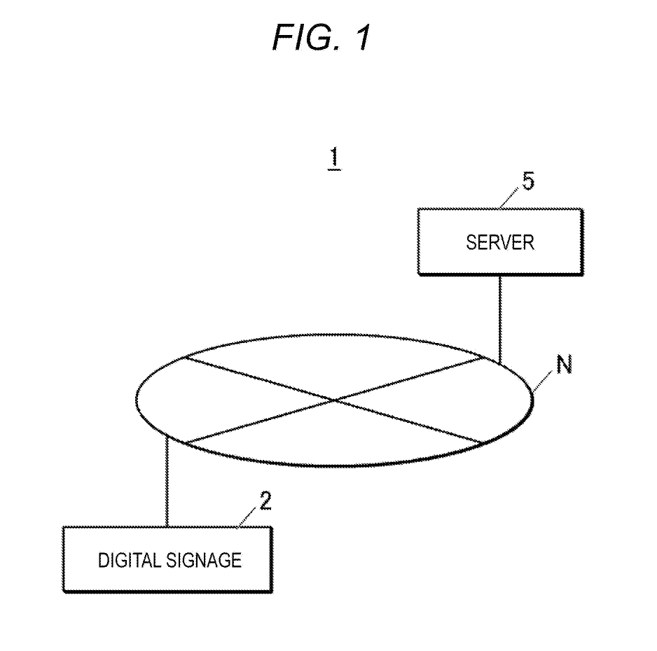

FIG. 1 is a block diagram illustrating a schematic configuration of a display system according to a first embodiment. The display system 1 includes a digital signage 2 as a display device according to an embodiment of the present invention, and a server 5 capable of communicating with the digital signage 2 through a network N. The server 5 stores data or the like of an advertisement displayed on the digital signage 2, and the stored data or the like is configured to be downloaded to the digital signage 2.

[Digital Signage]

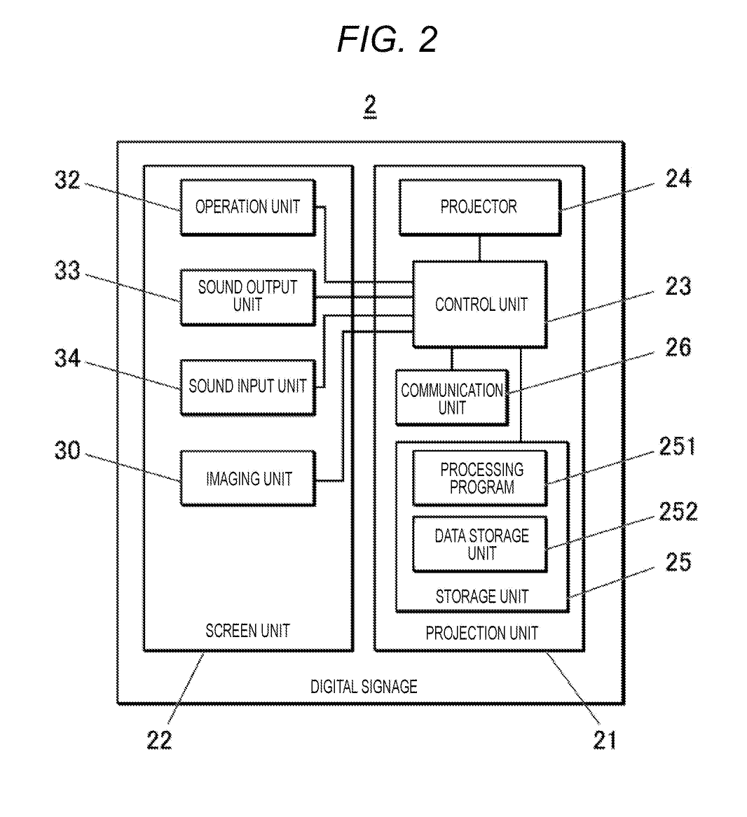

FIG. 2 is a block diagram illustrating a main control configuration of the digital signage 2. The digital signage 2 includes a projection unit 21 and a screen unit 22. The projection unit 21 radiates image projecting light of an image of an advertisement or the like. The screen unit 22 receives the image projecting light radiated from the projection unit 21 on a back side thereof and projects the received light toward a front side thereof. The projection unit 21 and the screen unit 22 will be described below.

The projection unit 21 includes a control unit 23, a projector 24, a storage unit 25, and a communication unit 26. The control unit 23 controls each unit based on a processing program and various data. The projector 24 is connected to the control unit 23, converts image data (data of images including moving and still images) output from the control unit 23 to the image projecting light, and radiates the light toward the screen unit 22. The storage unit 25 stores the processing program and the various data. The communication unit 26 communicates with the server 5 through the network N.

The screen unit 22 will be described next.

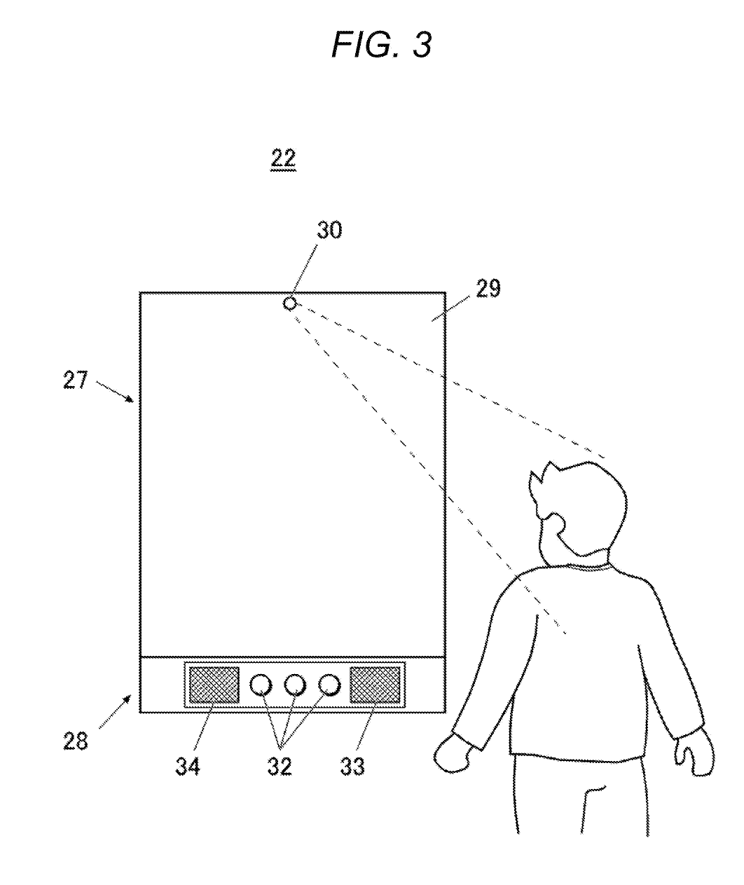

FIG. 3 is a front view illustrating a schematic configuration of the screen unit 22. As illustrated in FIG. 3, the screen unit 22 includes a square display panel 27 and a base 28 configured to support the display panel 27.

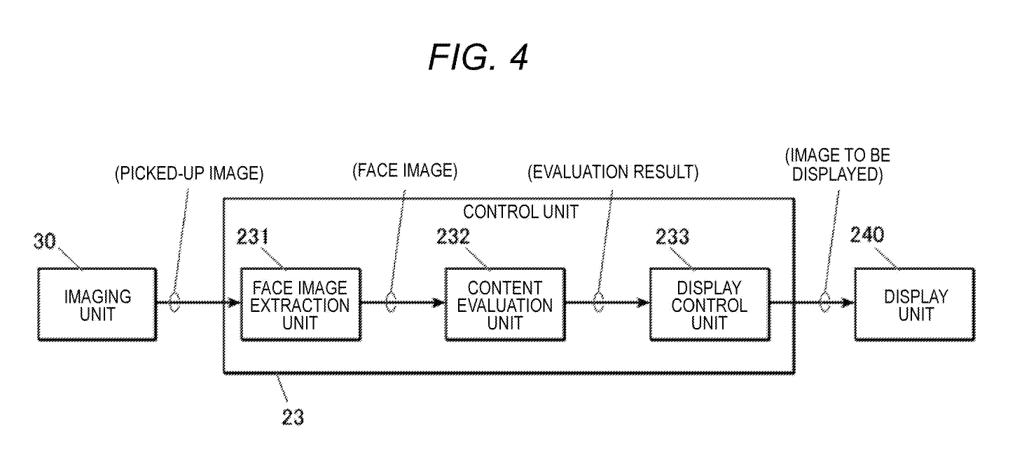

The display panel 27 includes one translucent panel 29, for example an acrylic sheet, substantially orthogonal to a direction in which the image projecting light is radiated. The translucent panel 29 has a back side on which a back projection film screen is laminated. The film screen has a back surface on which a film-shaped Fresnel lens is laminated. The display panel 27 and the above-described projector 24 constitute a display unit 240 (see FIG. 4).

At an upper part of the display panel 27, an imaging unit 30, such as a camera, is provided. The imaging unit 30 picks up an image of a space facing the display panel 27 in real time to generate image data. The imaging unit 30 includes a camera including an optical system and an image sensor, and an imaging control unit configured to control the camera. The camera and the imaging control unit are not illustrated in the figure. Any of a visible light camera or an infrared camera may be used as the camera.

The camera has an optical system constituted by a plurality of lenses, and having a focal length fixed to a predetermined distance to increase a depth of field. The optical system has an optical axis oriented in a direction in which an image of a person's face facing the display panel 27 can be picked up.

The image sensor includes an image sensor such as a charge coupled device (CCD) or a complementary metal-oxide semiconductor (CMOS). The image sensor converts an optical image obtained through the optical system to a two-dimensional image signal.

The imaging control unit controls picking up an image of a specific object by the image sensor. That is, the imaging control unit includes a timing generator, a driver, and the like which are not illustrated. In the imaging control unit, the timing generator and the driver drive the image sensor to perform scanning, the optical image having been received is periodically converted to a two-dimensional image signal, a frame image is read for each screen from an imaging area of the image sensor, and the image data is generated.

The base 28 includes an operation unit 32 operated through a button, a sound output unit 33 such as a speaker, and a sound input unit 34 such as a microphone.

The operation unit 32, the sound output unit 33, the sound input unit 34, and the imaging unit 30 are connected to the control unit 23, as illustrated in FIG. 2.

The control unit 23 includes a CPU configured to execute various programs for predetermined calculation or control of each unit, and a memory serving as a work area upon execution of the program (neither is illustrated).

The control unit 23 performs various processing based on an operation signal from an operation unit 32, reads image data or sound data from the storage unit 25 as required, and performs display control of the projector 24 and sound output control of the sound output unit 33.

Further, the control unit 23 stores image data obtained from the imaging unit 30 and sound data obtained from the sound input unit 34 in the storage unit 25.

The control unit 23 controls the communication unit 26 for communication with the server 5, depending on an operation signal from the operation unit 32. Information obtained through the communication is stored in the storage unit 25.

[Display Control Processing in Digital Signage]

In the present embodiment, display control processing is performed in the digital signage 2.

Therefore, as illustrated in FIG. 2, the storage unit 25 of the digital signage 2 stores a processing program 251 for display control processing. Various data such as setting data, image data, and sound data required for the display control processing are stored in a data storage unit 252 in the storage unit 25.

The control unit 23 of the digital signage 2 is a so-called computer. The control unit 23 executes a processing program 251 for the display control processing, and functions as a face image extraction unit 231, a content evaluation unit 232, and a display control unit 233 as shown in FIG. 4.

It is noted that, in the following description, any of a picked-up image, a face image, an image to be displayed, and other images are made into data for processing.

The face image extraction unit 231 extracts the face image of a viewer from images picked up by the imaging unit 30.

Based on the extracted face image, the content evaluation unit 232 evaluates an advertisement having content of a kind displayed on the display unit 240.

The display control unit 233 switches among a plurality of kinds of advertisements to display any of them on the display unit 240, and determine content to be displayed on the display unit 240 based on an evaluation result of the content evaluation unit 232. Therefore, based on the expression of the viewer viewing an advertisement, an evaluation of the advertisement is made. Based on the evaluation result, for example, the advertisement is displayed for a longer period of time or the advertisement is switched to another one, whereby an advertisement to be displayed is allowed to be determined.

Further, supplementary description will be given of the units 231 to 233.

[Face Image Extraction Unit]

The face image extraction unit 231 extracts the face image from the images picked up by the imaging unit 30 based on a predetermined algorithm.

The face image extraction unit 231 extracts the face image from the images picked up by the imaging unit 30 using, for example, the adaboost algorithm.

The adaboost algorithm uses a plurality of classifiers having a low accuracy in recognition of face image (e.g., recognition accuracy slightly higher than 0.5). The classifiers are previously weighted, respectively, based on learning using a sample face image and a non-face image.

The face image extraction unit 231 searches the whole picked-up images with the classifiers. As a result, the face image extraction unit 231 recognizes that a face is in an area in which the total of scores (weighted scores) obtained from the classifiers is equal to or larger than a predetermined threshold.

The classifier uses, for example, a plurality of pattern images called Haar-Like feature which expresses a partial face feature with black and white rectangular areas and arrangement thereof. The pattern images are also weighted, respectively, based on the learning using a sample face image and a non-face image. The scores of the classifier is calculated based on a determination result of coincidence between the pattern image and a searched area of the picked-up image.

The searched area is used for extracting the face image, and has a plurality of sizes. The classifiers are also prepared corresponding to the plurality of sizes. The face image is detected based on various sizes. As a result, not only the position of the face image within the range of picking up the image but also the size of the face image can be obtained.

It is noted that the present invention provides an exemplary process of extracting the face image using the face image extraction unit 231, but any other well-known technique for extracting the face image can be employed without being restricted to the above-mentioned process.

[Content Evaluation Unit]

First, the content evaluation unit 232 determines that the face image extracted from the face image extraction unit 231 is similar to any of a plurality of kinds of expressions to recognize the expression of the face image. In the present embodiment, based on a result of recognition thereof, evaluation of the advertisement display on the display unit 240 is made.

The kind of expression includes, for example, an expression showing a positive emotion such as a delighted face, joyful face, happy face, calm face, or relaxed face, or an expression showing a negative emotion such as a sad face, angry face, or disgusted face. It is noted that the type of expression is not limited to them, increased expressions or reduced expressions can be also determined, and an expression other than the above-mentioned expressions can be determined.

For determination of the expression, for example, the adaboost algorithm can be used.

In the determination thereof, during learning, a plurality of classifiers is generated using an image representing any one of the various expressions and an image representing another expression. Further, the classifier preferably has a pattern image of Haar-Like feature. Therefore, the plurality of classifiers each configured to identify one kind of expression, is obtained.

Further, a similar process is applied to generate a plurality of classifiers for various expressions, respectively, for identification of the other kinds of expressions.

In such a configuration, evaluation values are set to the above-mentioned expressions. A positive value or a positive evaluation value is set to the positive emotion. A negative value or a negative evaluation value is set to the negative emotion. It is noted that the evaluation value may differ for each expression, and a plurality of expressions may have the same evaluation value. The process of obtaining an evaluation value is an example, and another well-known expression evaluating method can be employed without being limited to the above-mentioned process.

The content evaluation unit 232 derives, as described above, evaluation values for the face images picked up at predetermined intervals and extracted by the face image extraction unit 231, averages the evaluation values to derive an affirmation level Pe based on expression recognition, and evaluates, based on the affirmation level Pe, the advertisement of a kind displayed on the display unit 240. The affirmation level Pe is derived from the following formula (1), where “E” represents the evaluation values obtained at predetermined intervals, and “N” represents the number of times of obtaining the evaluation values or an expression recognition frequency.

Affirmation level Pe=ΣE/N (1)

The content evaluation unit 232 recognizes a line of sight to the display panel 27 based on a face image extracted from the face image extraction unit 231, and evaluates an expression of the face image on condition that the line of sight is recognized. When the content evaluation unit 232 does not recognize the line of sight, the evaluation of the expression of the face image is not carried out.

The recognition of line of sight to the display panel 27 can be carried out based on the face image by, for example, setting an inner corner of a viewer's eye as a reference point, setting an iris thereof as a moving point, and determining a positional relationship between the inner corner and the iris of the viewer's eye. It is noted that the process for recognition of line of sight is not limited to this embodiment, and various methods which have been publicly known can be employed.

The content evaluation unit 232 recognizes (detects) the line of sight to the display panel 27 based on the face image extracted from the face image extraction unit 231, and evaluates, based on a result of the recognition of line of sight, the advertisement of a kind displayed on the display unit 240. In the present embodiment, the content evaluation unit 232 derives time for recognition of line of sight to the display panel 27, and a frequency of shift of the line of sight from the display panel 27. An affirmation level P1 based on recognition of line of sight is derived from the time and frequency. Based on the affirmation level P1, the content evaluation unit 232 evaluates the advertisement of a kind displayed on the display unit 240. The affirmation level P1 is derived from the following formula (2), where, “Ton” represents time for recognition of line of sight to the display panel 27, and “Nout” represents a frequency of shift of the line of sight from the display panel 27.

Affirmation level P1=Ton*k1−Nout*k2 (2)

It is noted that in formula (2), k1 and k2 represent a count for time for recognition of line of sight to the display panel 27, and a coefficient for the frequency of shift of the line of sight from the display panel 27, respectively.

In the present embodiment, based on the time for recognition of line of sight to the display panel 27, evaluation is carried out for the advertisement of a kind displayed on the display unit 240, but evaluation may be carried out for the advertisement of a kind displayed on the display unit 240 not based on the time for recognition but based on a frequency of recognition of line of sight.

The content evaluation unit 232 derives an affirmation level P being the evaluation for the advertisement display on the display unit 240 based on the affirmation level Pe and the affirmation level P1 which are derived as described above. Specifically, the affirmation level P is derived by the following formula (3).

Affirmation level P=affirmation level Pe+affirmation level P1 (3)

It is noted that the affirmation level Pe and the affirmation level P1 may be weighted, respectively.

In the present embodiment, the affirmation level P is derived as described above, but for example, as described in JP 2013-051688 A, the affirmation level P may be derived based on a direction of the viewer's face.

[Display Control Unit]

The display control unit 233 controls the display unit 240 to switch and display a plurality of kinds of advertisements.

The display control unit 233 determines an advertisement to be displayed on the display unit 240 based on an evaluation result of the content evaluation unit 232. It will be described below which advertisement is displayed.

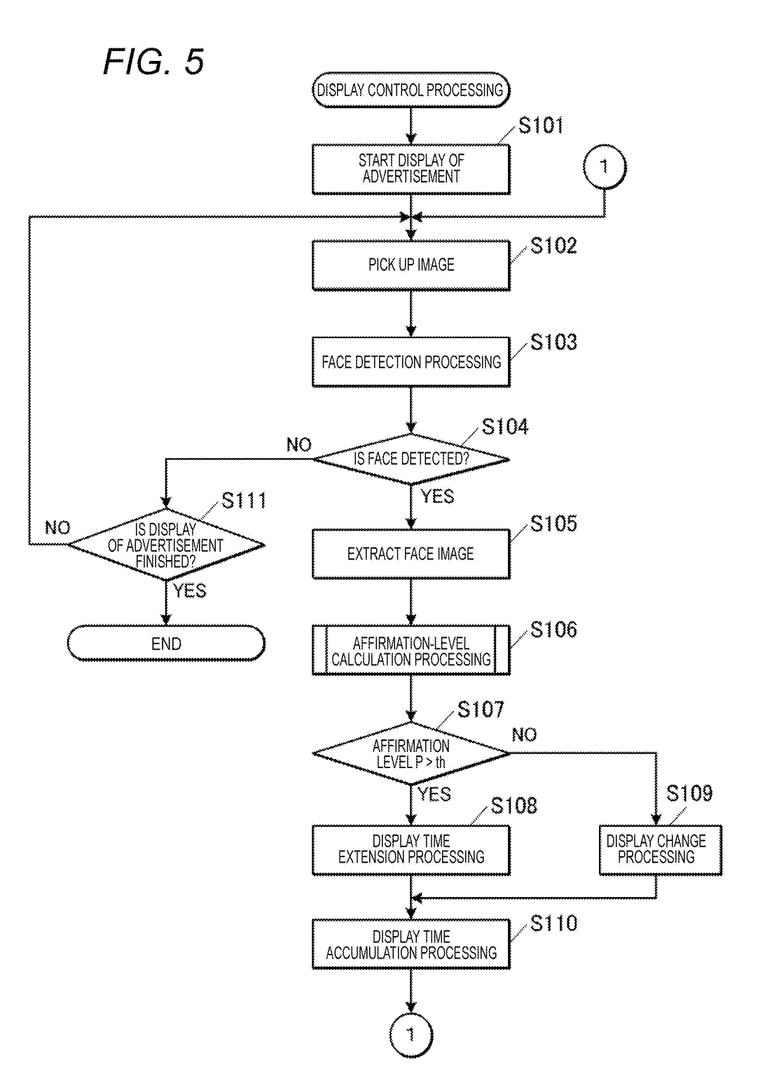

The display control processing performed at the control unit 23 of the digital signage 2 configured as described above, will be described with reference to FIG. 5.

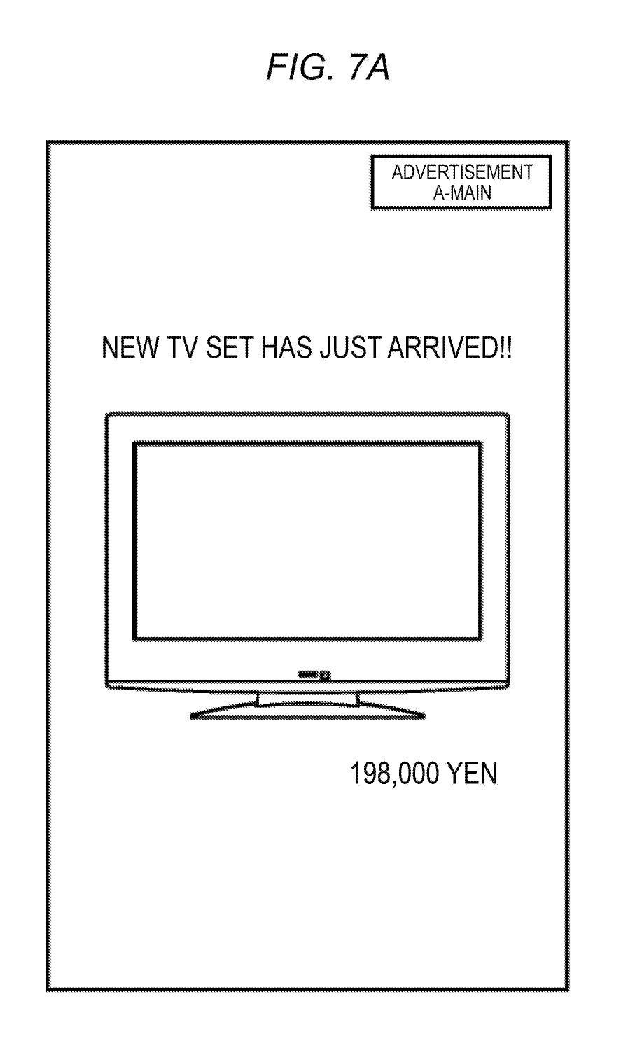

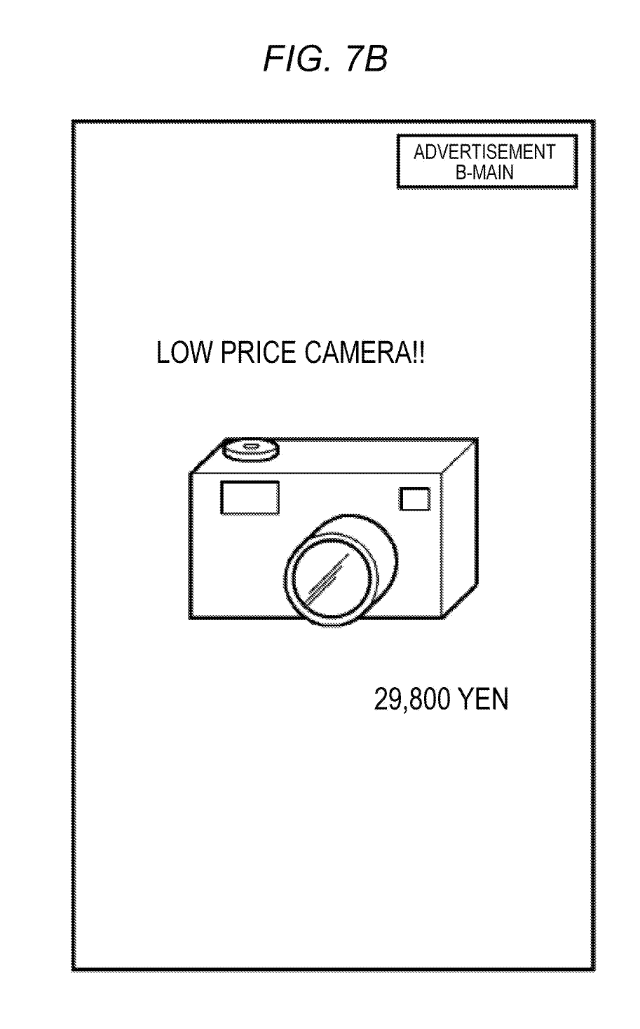

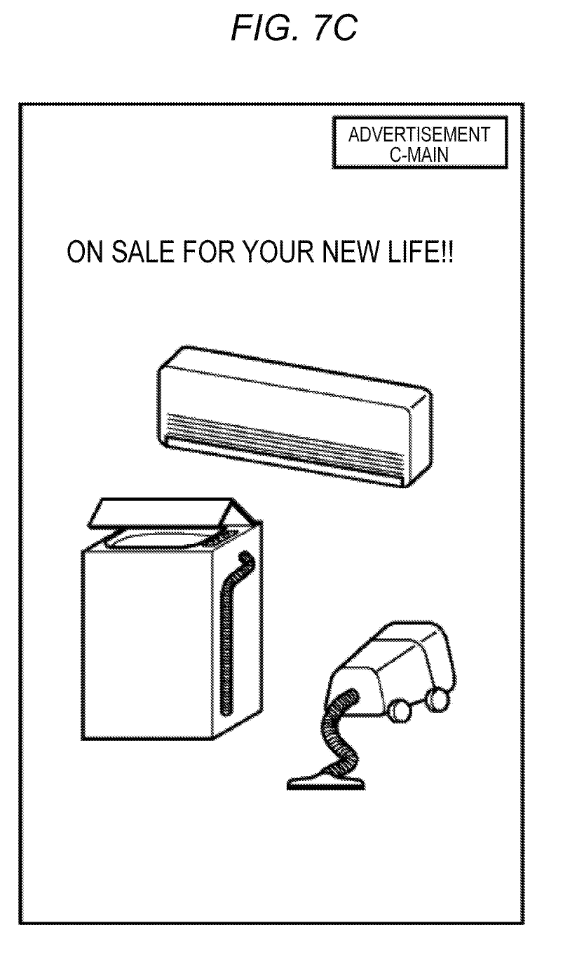

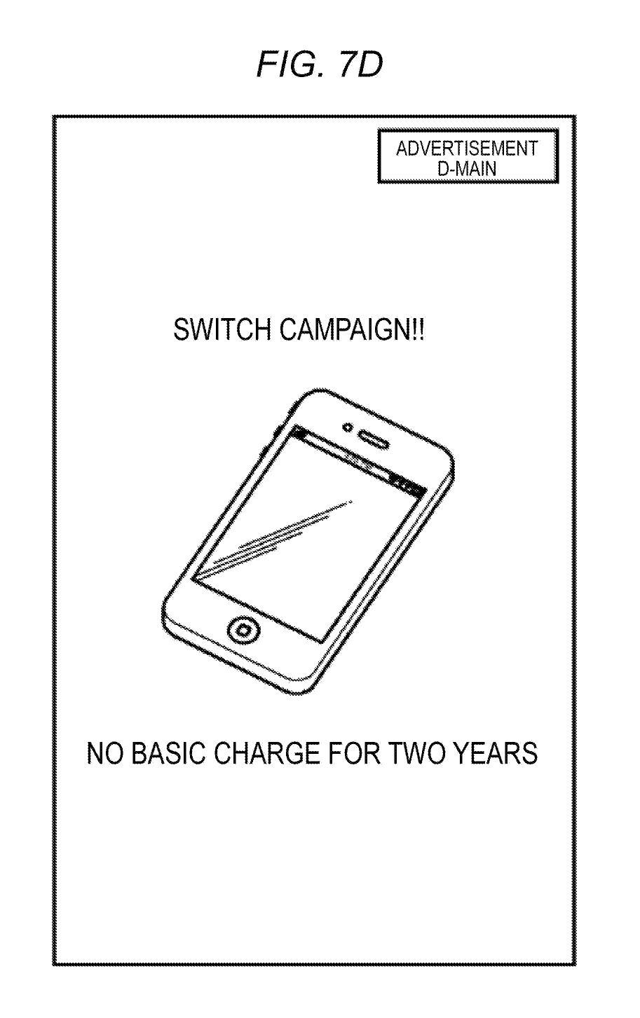

First, the control unit 23 starts display of the advertisement as the content (step S101). Specifically, for example, four kinds of advertisements illustrated in FIG. 7A to FIG. 7D are switched to be displayed every predetermined time (e.g. 10 seconds) on the display unit 240. More specifically, the display is switched every predetermined time in an order of an “advertisement A-main” image illustrated in FIG. 7A, an “advertisement B-main” image illustrated in FIG. 7B, an “advertisement C-main” image illustrated in FIG. 7C, an “advertisement D-main” image illustrated in FIG. 7D, and an “advertisement A main” image illustrated in FIG. 7A. The display control is performed in parallel with the following processing.

Next, the control unit 23 causes the imaging unit 30 to pick up an image of a space in front of the display panel 27 of the digital signage 2 (step S102).

The control unit 23 performs face detection processing for detecting the face image from the picked-up image (step S103). The control unit 23 determines whether the face image has been detected or not (step S104). When it is determined that the face image has been detected (step S104:Y), the control unit 23 causes the face image extraction unit 231 to function to extract the face image from the picked-up images (step S105).

The control unit 23 performs affirmation-level calculation processing based on the extracted face image (step S106).

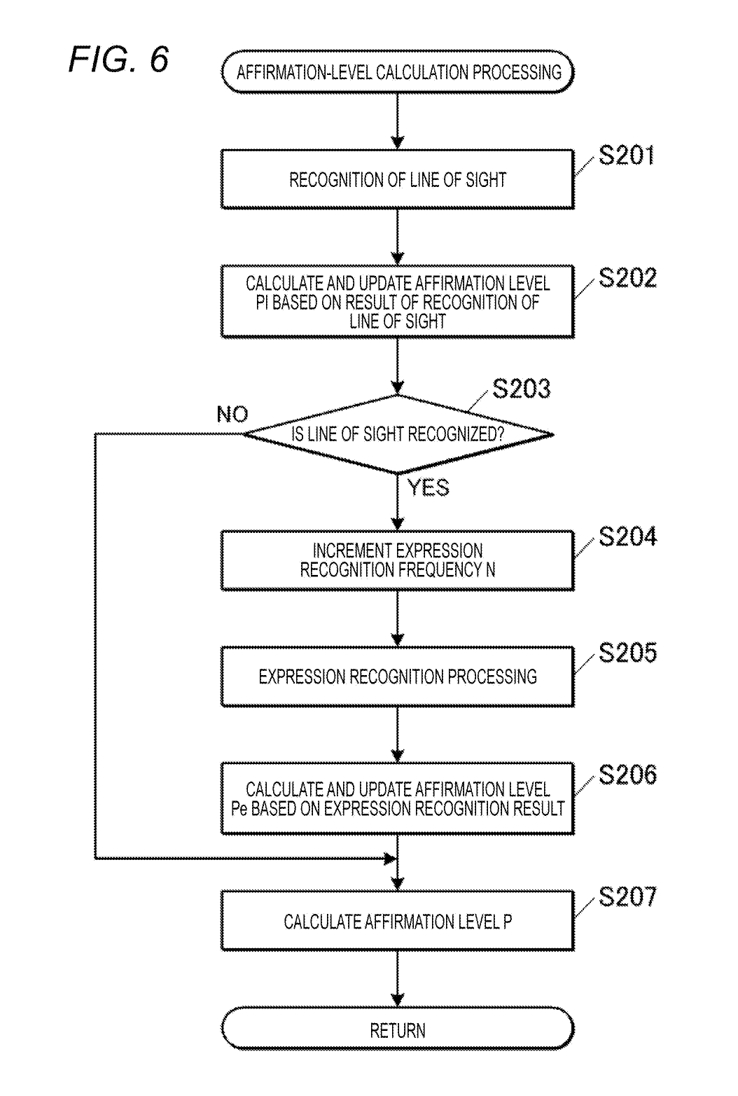

The affirmation-level calculation processing will be described with reference to FIG. 6.

The control unit 23 recognizes the line of sight to the display panel 27, as described above (step S201). Further, the control unit 23 calculates the affirmation level P1 based on recognition of line of sight from a result of the recognition of line of sight, as described above, and a result of the calculation is newly stored for example in a memory as a latest affirmation level P1 (step S202).

After the recognition of line of sight, the control unit 23 determines whether the line of sight to the display panel 27 has been recognized (step S203). When it is determined that the line of sight has been recognized (step S203:Y), the control unit 23 increments the expression recognition frequency N (step S204), and performs expression recognition processing for recognizing an expression of the face image as described above (step S205).

The control unit 23 acquires an evaluation value based on a result of recognition of the expression, calculates the affirmation level Pe based on the expression recognition as described above, and newly stores the result for example in the memory as the latest affirmation level Pe (step S206).

When it is determined in step S203 that the line of sight has not been recognized (step S203:N), the control unit 23 performs the processing of step S207 without performing processing of steps S204 to S206.

In step S207, the control unit 23 calculates the affirmation level P from the latest affirmation level Pe and the affirmation level P1 which have been derived as described above (step S207), and the processing is finished.

Returning to FIG. 5, in step S107, the control unit 23 determines whether the affirmation level P calculated in the affirmation-level calculation processing exceeds a predetermined threshold th (step S107). When it is determined that the affirmation level P exceeds the threshold th (step S107:Y), the control unit 23 determines that the viewer has an interest in the advertisement of a kind being displayed on the display unit 240 at present, and performs display time extension processing for extending time for displaying the advertisement (step S108). The extension time of the display is set to, for example, ten seconds, but the present invention is not limited to this embodiment. When it is determined that the affirmation level P does not exceed the threshold th (step S107:N), the control unit 23 determines that the viewer does not have an interest in the advertisement of a kind being displayed on the display unit 240 at present, and performs display change processing for changing the advertisement of the kind being displayed on the display unit 240 at present to an advertisement of another kind (step S109). For example, the “advertisement A-main” image which is displayed on the display unit 240, as illustrated in FIG. 7A, is changed to another “advertisement B-main” image illustrated in FIG. 7B. It is noted that the advertisement after being changed may be selected at random.

The control unit 23 performs display time accumulation processing of accumulating display time of advertisements of a kind being displayed on the display unit 240 at present, and newly storing the time in the memory, for example (step S110), and proceeds to the processing of step S102. Therefore, for each kind of advertisement, the display time on the display unit 240 can be calculated, and for example, the calculated time can be used for marketing.

When it is determined in step S104 that the face image has not been detected (step S104:N), the control unit 23 determines whether to terminate display of the advertisement (step S111). More specifically, for example, it is determined whether to terminate the display of the advertisement, based on whether predetermined termination operation has been performed. When it is determined that the display of the advertisement is not terminated (step S111:N), the control unit 23 advances the processing to step S102. Meanwhile, when it is determined to terminate the display of the advertisement, (step S111:Y), the control unit 23 finishes this processing.

As described above, in the first embodiment, the advertisement is displayed on the display unit 240 for a longer period of time or the content of the advertisement is changed according to the expression of the viewer viewing the advertisement. Therefore, the interest of the viewer is reflected, and an advertising effect is increased. Since the display system does not require the viewer, for example, to select one from the displayed contents of the advertisement to change the advertisement, the display system provides a high advertising effect, even if the viewer does not have a strong interest in the advertisement.

### Second Embodiment

Next, a second embodiment of the present invention will be described below. It is noted that description of a functional configuration of a digital signage 2 according to the second embodiment will be omitted, since the functional configuration is similar to that of the digital signage described above according to the first embodiment.

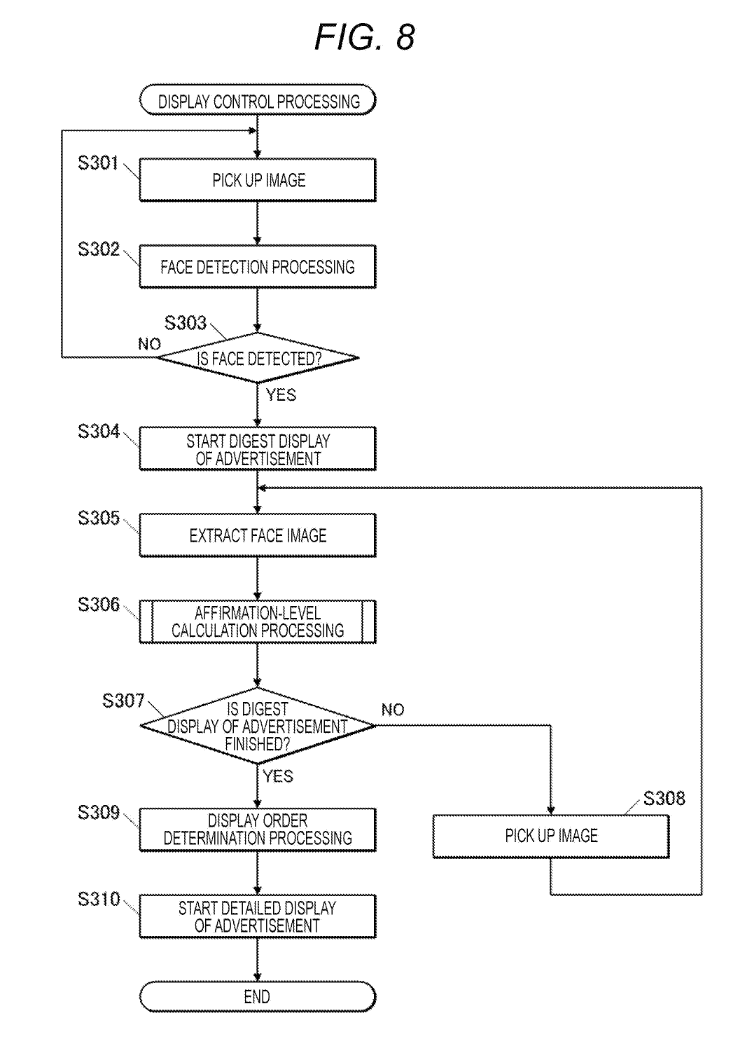

Display control processing according to the second embodiment will be described with reference to FIG. 8.

First, a control unit 23 causes an imaging unit 30 to pick up an image of a space in front of a display panel 27 of the digital signage 2 (step S301).

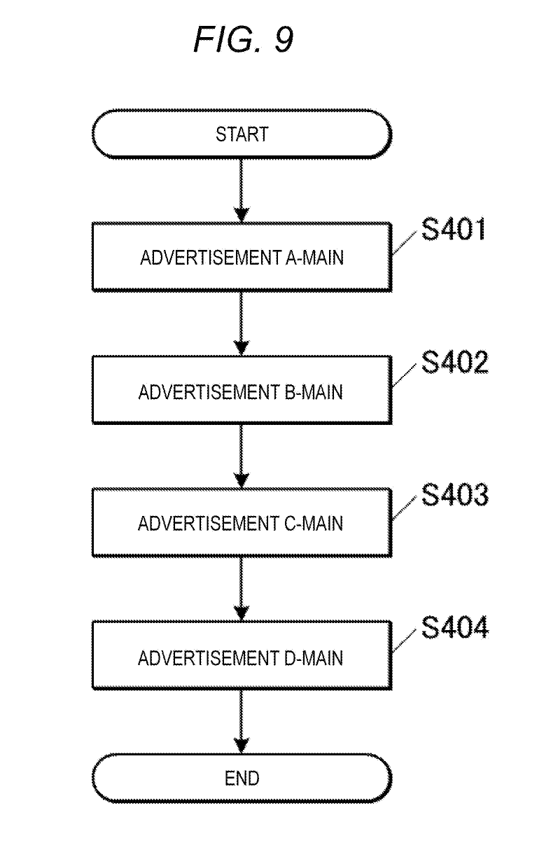

The control unit 23 performs face detection processing for detecting a face image from the picked-up image (step S302). The control unit 23 determines whether the face image has been detected (step S303). When it is determined that the face image has been detected (step S303:Y), the control unit 23 starts display of an advertisement as content (step S304). In such a configuration, for example, four kinds of advertisements illustrated in FIGS. 7A to 7D are displayed on a display unit 240 in a digested manner, while being switched every predetermined time. That is, as illustrated in FIG. 9, the control unit 23 displays an “advertisement A-main” image for a predetermined time (e.g. three seconds) (step S401), an “advertisement B-main” image for a predetermined time (step S402), an “advertisement C-main” image for a predetermined time (step S403), and an “advertisement D-main” image for a predetermined time (step S404) in the digested manner, and finishes the digest display.

Then, the control unit 23 causes the face image extraction unit 231 to function to extract the face image from the picked-up image (step S305), and performs the affirmation-level calculation processing (step S306).

The control unit 23 determines whether the digest display of the advertisements is finished (step S307). When it is determined that the digest display is not finished (step S307:N), the control unit 23 causes the imaging unit 30 to pick up an image (step S308) followed by processing of step S305. The control unit 23 repeats the processing of steps S305 to S308 until the finish of the digest display, and calculates the affirmation level for each kind of advertisement.

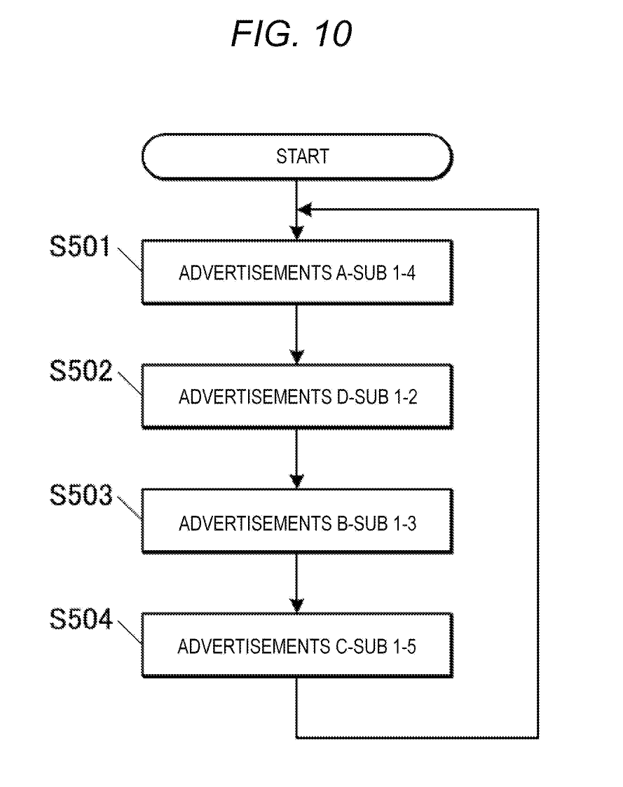

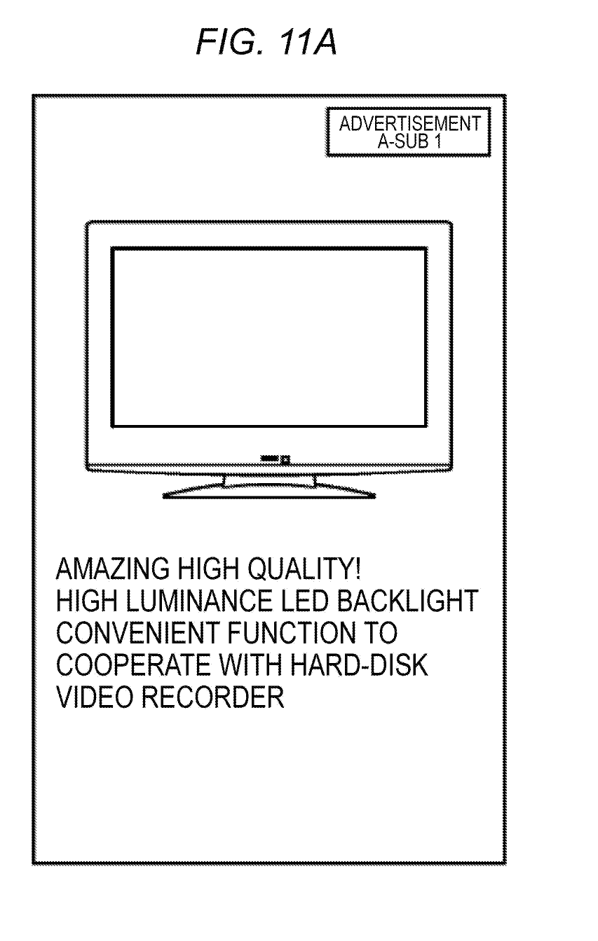

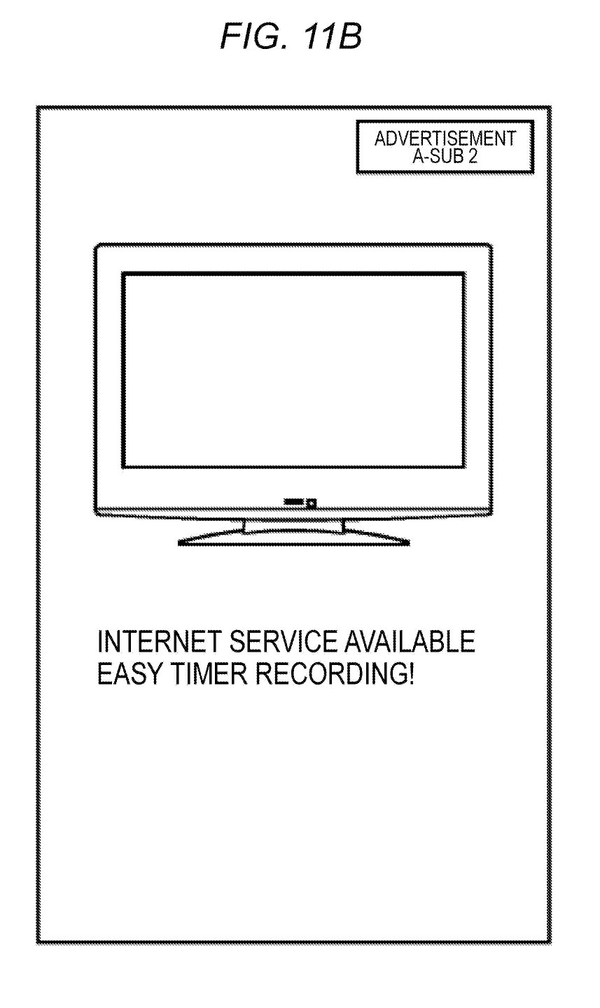

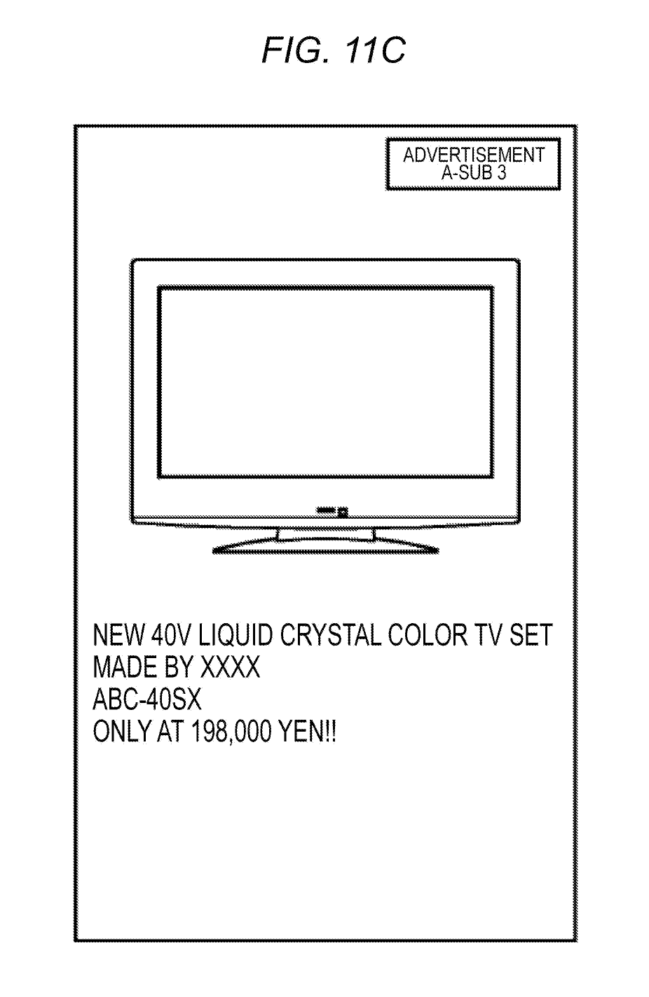

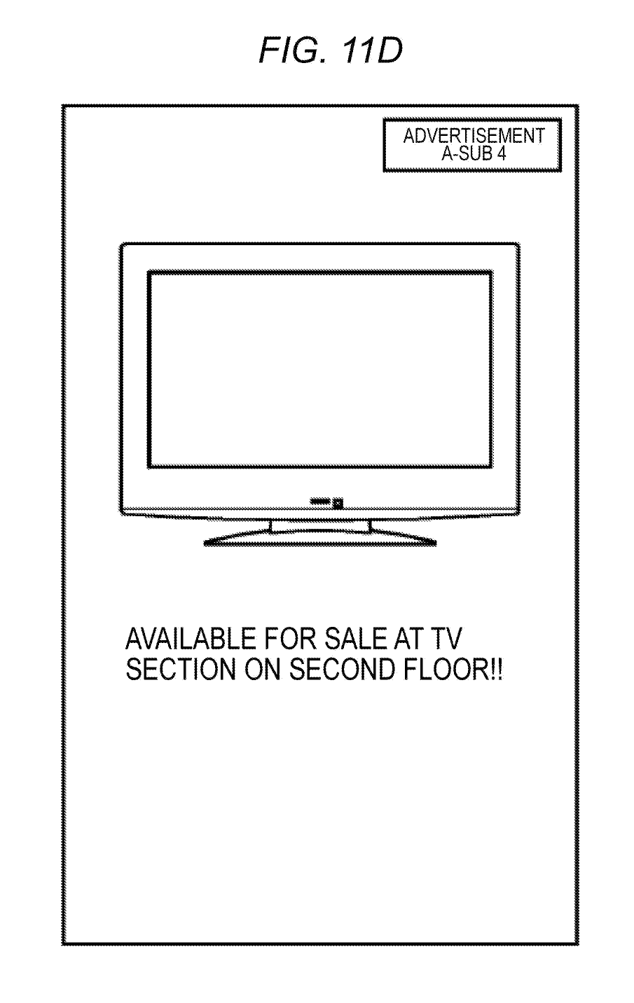

Meanwhile, when it is determined that the digest display is finished (step S307:Y), the control unit 23 performs display order determination processing for determining an order of displaying detailed advertisements, based on affirmation levels of advertisements according to kinds (step S309). More specifically, the control unit 23 determines the display order to display the detailed advertisements in descending order of affirmation levels. The control unit 23 starts the display of the detailed advertisements in the display order determined in step S309 (step S310). For example, when calculation of affirmation level for each kind of advertisement results in descending order of affirmation levels in the order of an advertisement A, an advertisement D, an advertisement B, and an advertisement C, at first, an “advertisement A-sub” image is displayed as detailed display of the advertisement A, next, an “advertisement D-sub” image is displayed as detailed display of the advertisement D, and then an “advertisement B-sub” image is displayed as detailed display of the advertisement B, and finally, an “advertisement C-sub” image is displayed as detailed display of the advertisement C. In such a configuration, when the “advertisement A-sub” image includes four images, the “advertisement B-sub” image includes three images, the “advertisement C-sub” image includes five images, and the “advertisement D-sub” image includes two images, the control unit 23 first displays, as illustrated in FIG. 10, an “advertisement A-sub 1” image to an “advertisement A-sub 4” image for a predetermined time (e.g. five seconds), respectively (step S501), an “advertisement D-sub 1” image to an “advertisement D-sub 2” image for a predetermined time, respectively (step S502), an “advertisement B-sub 1” image to an “advertisement B-sub 3” image for a predetermined time, respectively (step S503), and an “advertisement C-sub 1” image to an “advertisement C-sub 5” image for a predetermined time, respectively (step S504), and the procedure is repetitively performed. In such a configuration, the “advertisement A-sub 1” image includes, for example, an image as illustrated in FIG. 11A, the “advertisement A-sub 2” image includes, for example, an image as illustrated in FIG. 11B, the “advertisement A-sub 3” image includes, for example, an image as illustrated in FIG. 11C, and the “advertisement A-sub 4” image includes, for example, an image as illustrated in FIG. 11D. The “advertisement A-sub” images are detailed images displayed relating to the advertisement A-main” image illustrated in FIG. 7A. The “advertisement B-sub” images, “advertisement C-sub” images, and “advertisement D-sub” images also have a plurality of detailed images displayed relating to the “advertisement B-main” image, the “advertisement C-main” image, and the “advertisement D-main” image, respectively, in a similar manner.

In such a manner, in the second embodiment, the order of detailed display of the advertisement displayed on the display unit 240 is determined according to viewer's expression viewing the advertisement. Therefore, the viewer can see the advertisement in the order of interest, and the advertising effect is increased reflecting the interest of the viewer.

### Third Embodiment

Next, a third embodiment of the present invention will be described below. It is noted that description of a functional configuration of a digital signage 2 according to the third embodiment will be omitted, since the functional configuration is similar to that of the digital signage described above according to the first embodiment.

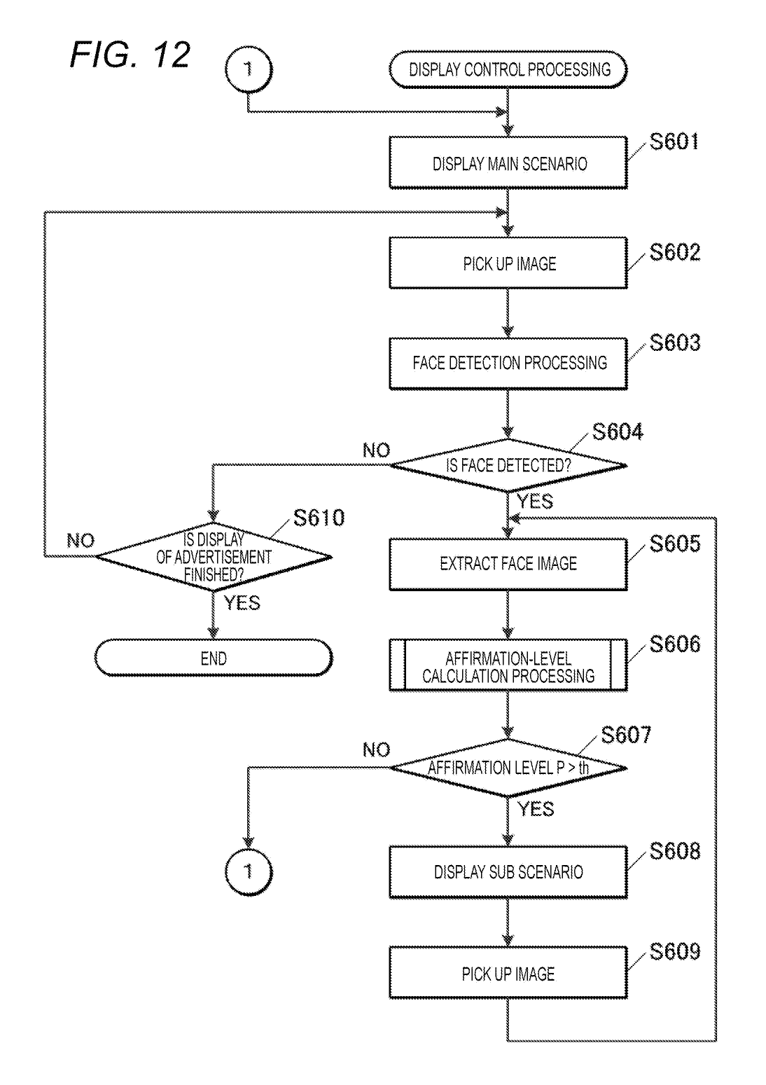

Display control processing according to the third embodiment will be described with reference to FIG. 12.

First, a control unit 23 starts display of an advertisement having a main scenario as content (step S601). More specifically, for example, four kinds of advertisements illustrated in FIGS. 7A to 7D are switched to be displayed every predetermined time (e.g. 10 seconds) on the display unit 240. That is, the control unit 23 switches the display every predetermined time, in an order of the “advertisement A-main” image illustrated in FIG. 7A, the “advertisement B-main” image illustrated in FIG. 7B, the “advertisement C-main” image illustrated in FIG. 7C, the “advertisement D-main” image illustrated in FIG. 7D, and the “advertisement A-main” image illustrated in FIG. 7A. The display control is performed simultaneously with the following processing.

Next, the control unit 23 causes the imaging unit 30 to pick up an image of a space in front of the display panel 27 of the digital signage 2 (step S602).

The control unit 23 performs face detection processing for detecting a face image from the picked-up image (step S603). The control unit 23 determines whether a face image has been detected (step S604). When it is determined that the face image has been detected (step S604:Y), the control unit 23 causes the face image extraction unit 231 to function to extract the face image from the picked-up images (step S605), and performs the affirmation-level calculation processing based on the extracted face image (step S606).

The control unit 23 determines whether an affirmation level P calculated in the affirmation-level calculation processing exceeds a threshold th (step S107). When it is determined that the affirmation level P exceeds the threshold th (step S607:Y), the control unit 23 determines that the viewer has an interest in the advertisement of a kind being displayed on the display unit 240 at present, and an advertisement having a sub scenario relating to the advertisement having the main scenario is displayed (step S608). For example, while the “advertisement A-main” image is displayed, as the advertisement having the main scenario, on the display unit 240, the control unit 23 switches and displays the “advertisement A-sub 1” image to the “advertisement A-sub 4” image relating to the “advertisement A-main” image for a predetermined time (e.g. five seconds), respectively, when it is determined that the calculated affirmation level P exceeds the threshold th.

Subsequently, the control unit 23 advances the processing to step S605, after picking up the image by the imaging unit 30 (step S609). For example, when the “advertisement A-sub” image is displayed, the control unit 23 repetitively displays the “advertisement A-sub” image, as long as it is determined that the affirmation level P exceeds the threshold th in step S607. Display of the advertisement having the sub scenario may be finished to be switched to the display of the advertisement having the main scenario.

When it is determined in step S607 that the affirmation level P does not exceed the threshold th (step S607:N), the control unit 23 determines that the viewer does not have an interest in the advertisement of a kind being displayed on the display unit 240 at present, and advances the processing to step S601 for displaying the advertisement having the main scenario. It is noted that the present embodiment may be configured such that on condition that the advertisement having the sub scenario has completed, the advertisement may be shifted to the one having the main scenario, when it is determined that the affirmation level P does not exceed the threshold th. Alternatively, the present embodiment may be configured such that the advertisement having the sub scenario may be shifted to the one having the main scenario during display of the advertisement having the sub scenario, when it is determined that the affirmation level P does not exceed the threshold th.

When it is determined that the face image has not been detected in step S604 (step S604:N), the control unit 23 determines whether to terminate display of the advertisement (step S610). When it is determined that the display of the advertisement is not finished (step S610:N), the control unit 23 advances the processing to step S602. Meanwhile, when it is determined to terminate the display of the advertisement, (step S610:Y), the control unit 23 finishes this processing.

The present embodiment is configured as described above, and for example, the advertisements are switchably displayed as described below.

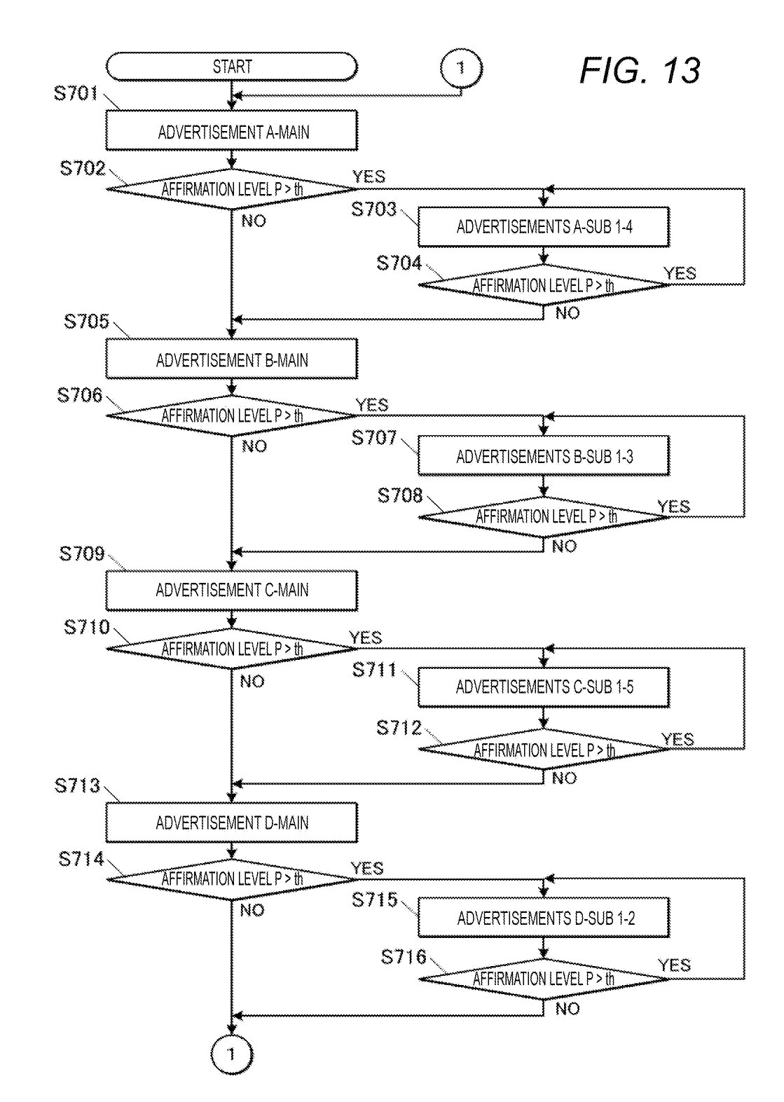

As illustrated in FIG. 13, the control unit 23 first displays the “advertisement A-main” image for a predetermined time (step S701). At that time, when it is determined that the affirmation level P exceeds the threshold th (step S702:Y), the control unit 23 displays the “advertisement A-sub 1” image to “advertisement A-sub 4” image for a predetermined time, respectively (step S703), and as long as the affirmation level P exceeds the threshold th (step S704:Y), the “advertisement A-sub” images are repetitively displayed.

In step S702 or step S704, when it is determined that the affirmation level P does not exceed the threshold th (step S702:N, step S704:N), the control unit 23 displays an “advertisement B-main” image for a predetermined time (step S705). At that time, when it is determined that the affirmation level P exceeds the threshold th (step S706:Y), the control unit 23 displays the “advertisement B-sub 1” image to “advertisement B-sub 3” image for a predetermined time, respectively (step S707), and as long as the affirmation level P exceeds the threshold th (step S708:Y), the “advertisement B-sub” images are repetitively displayed.

In step S706 or step S708, when it is determined that the affirmation level P does not exceed the threshold th (step S706:N, step S708:N), the control unit 23 displays the “advertisement C-main” image for a predetermined time (step S709). At that time, when it is determined that the affirmation level P exceeds the threshold th (step S710:Y), the control unit 23 displays the “advertisement C-sub 1” image to “advertisement C-sub 5” image for a predetermined time, respectively (step S711), and as long as the affirmation level P exceeds the threshold th (step S712:Y), the “advertisement C-sub” images are repetitively displayed.

In step S710 or step S712, when it is determined that the affirmation level P does not exceed the threshold th (step S710:N, step S712:N), the control unit 23 displays an “advertisement D-main” image for a predetermined time (step S713). At that time, when it is determined that the affirmation level P exceeds the threshold th (step S714:Y), the control unit 23 displays the “advertisement D-sub 1” image to “advertisement D-sub 2” image for a predetermined time, respectively (step S715), and as long as the affirmation level P exceeds the threshold th (step S716:Y), the “advertisement D-sub” images are repetitively displayed.

In step S714 or step S716, when it is determined that the affirmation level P does not exceed the threshold th (step S714:N, step S716:N), the control unit 23 advances the processing to step S701. Subsequently, these processing is repetitively performed.

As described above, the third embodiment is configured such that the advertisement in which the viewer has an interest is determined based on the viewer's expression viewing the advertisement, and the advertisement in which the viewer has an interest can be displayed in detail. Therefore, the viewer's interest is reflected to increase the advertising effect. Further, in the third embodiment, the display system does not require the viewer to select a required advertisement, so that the viewer does not have any trouble, and the advertising effect is increased.

### Fourth Embodiment

Next, a fourth embodiment of the present invention will be described below. It is noted that description of a functional configuration of the digital signage 2 according to the fourth embodiment will be omitted, since the functional configuration is similar to that of the digital signage described above according to the first embodiment.

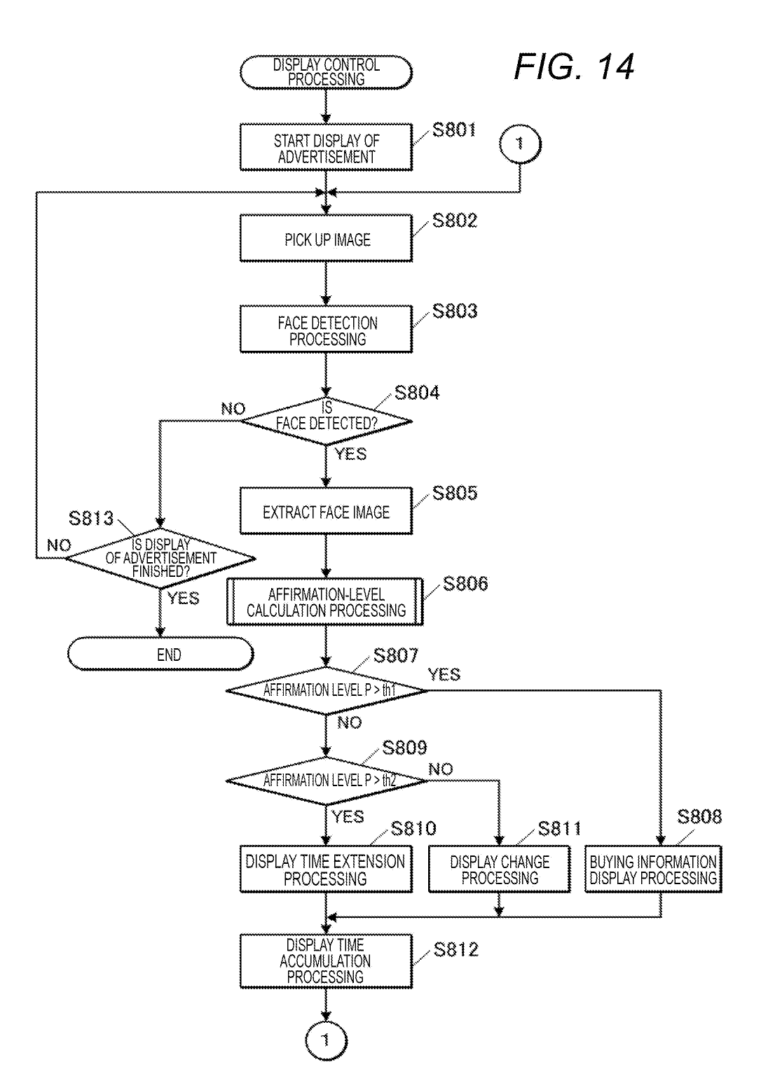

Display control processing according to the fourth embodiment will be described with reference to FIG. 14. The fourth embodiment is different from the first embodiment in that an affirmation level P has a threshold th1 and a threshold th2 set to be smaller than the threshold th1, and it is determined whether the affirmation level P exceeds any of the thresholds to determine an advertisement to be displayed on the display unit 240. It is noted that in the display control processing illustrated in FIG. 14, a similar procedure is applied to step S801 to step S806 as that in step S101 to step S106 of the display control processing according to the first embodiment illustrated in FIG. 5, and thus the description will not be repeated.

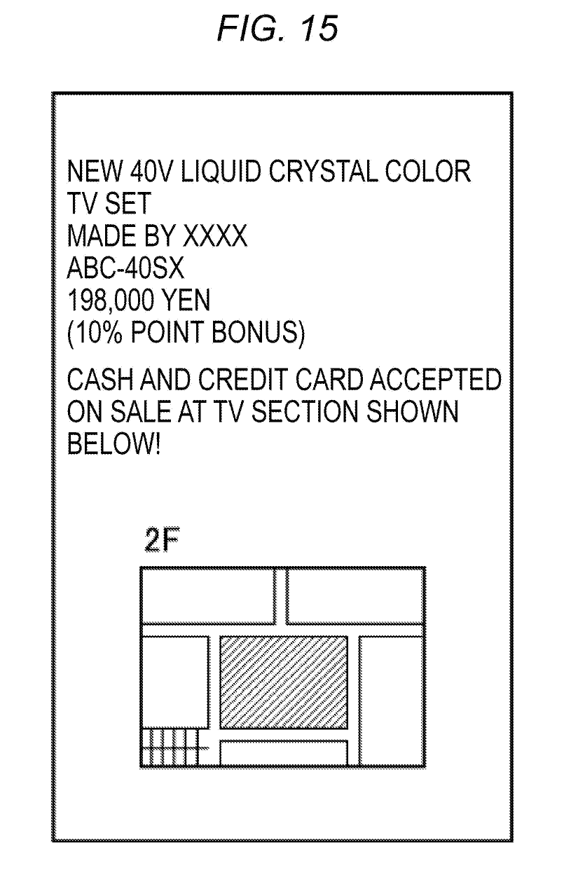

In step S807, a control unit 23 determines whether the affirmation level P calculated in the affirmation-level calculation processing exceeds the threshold th1 (step S807). The control unit 23 determines whether the affirmation level P has a first affirmative evaluation. When it is determined that the affirmation level P exceeds the threshold th1 (step S807:Y), the control unit 23 determines that the viewer has a great interest in the advertisement of a kind being displayed on the display unit 240 at present, and buying information display processing is performed for displaying buying information relating to the advertisement (step S808). For example, the buying information includes an advertisement as illustrated in FIG. 15, and displays, for example, a method for buying a product displayed in the advertisement, a product display place, or the like.

Meanwhile, when it is determined that the affirmation level P does not exceed the threshold th1 (step S807:N), the control unit 23 determines whether the affirmation level P exceeds the threshold th2 (step S809). That is, the control unit 23 determines whether the affirmation level P has a second affirmative evaluation. When it is determined that the affirmation level P exceeds the threshold th2 (step S809:Y), the control unit 23 determines that the viewer has some interest in an advertisement of a kind being displayed on the display unit 240 at present, and performs the display time extension processing (step S810). When it is determined that the affirmation level P does not exceed the threshold th2 (step S809:N), the control unit 23 determines that the viewer does not have an interest in the advertisement of a kind being displayed on the display unit 240 at present, and the display change processing is performed (step S811).

Subsequently, the control unit 23 advances the processing to step S802, after the display time accumulation processing has been performed (step S812).

When it is determined in step S804 that the face image has not been detected (step S804:N), the control unit 23 determines whether to terminate display of the advertisement (step S813). When it is determined that the display of the advertisement is not finished (step S813:N), the control unit 23 advances the processing to step S802. When it is determined that the display of the advertisement is finished (step S813:Y), on the other hand, the control unit 23 finishes this processing.

As described above, in the fourth embodiment, detailed information relating to the advertisement displayed on the display unit 240 is displayed, the advertisement is displayed longer, or the content of the advertisement is changed according to the expression of the viewer viewing the advertisement, so that display is performed according to an interest degree of the viewer to increase the advertising effect.

As described above, according to the first to fourth embodiments, the display unit 240 displays an image thereon. The control unit 23 switchably displays a plurality of kinds of advertisements on the display unit 240. The control unit 23 evaluates the affirmation level of the advertisement displayed on the display unit 240. The control unit 23 determines the advertisement displayed on the display unit 240 based on the affirmation level. Accordingly, the interest of the viewer is reflected to increase the advertising effect.

According to the first to fourth embodiments, the imaging unit 30 picks up an image. The control unit 23 extracts an image of a person's face from the image picked up by the imaging unit 30. The control unit 23 evaluates an affirmation level of an advertisement displayed on the display unit 240 based on the face image. Accordingly, the interest degree of the viewer with respect to content displayed on the display unit is evaluated based on the face image of the viewer.

According to the first to fourth embodiments, the control unit 23 evaluates an expression based on an extracted face image, and evaluates an advertisement of a kind displayed on the display unit 240 based on the affirmation level of the expression of the face image. Accordingly, the interest of the viewer in content can be evaluated based on an expression of the viewer's face, and the advertising effect is increased.

According to the first to fourth embodiments, the control unit 23 determines which of a plurality of kinds of preset expressions an extracted face image resembles. Accordingly, an expression of a viewer's face is readily determined.

According to the first to fourth embodiments, the control unit 23 derives evaluation values representing an affirmation level of an expression of a face image at predetermined intervals, averages the evaluation values, and evaluates an advertisement of a kind displayed on the display unit 240 based on the averaged evaluation value. Accordingly, an expression of a viewer's face is accurately evaluated.

According to the first to fourth embodiments, the control unit 23 detects a line of sight to the display unit 240 from an extracted face image, and an expression of the face image is evaluated on condition that the line of sight has been detected. Accordingly, an expression of a viewer's face can be accurately evaluated.

According to the first to fourth embodiments, the control unit 23 detects a line of sight to the display unit 240 from an extracted face image, and evaluates an affirmation level of an advertisement of a kind displayed on the display unit 240 based on a result of detecting the line of sight. Accordingly, an interest of a viewer in content is more accurately grasped.

According to the first to fourth embodiments, the control unit 23 evaluates an affirmation level of an advertisement of a kind displayed on the display unit 240 based on time during which a line of sight to the display unit 240 has been detected. Accordingly, an interest of a viewer in content is more accurately grasped.

According to the first embodiment, when an advertisement displayed on the display unit 240 has an affirmation level evaluated to have a predetermined affirmative evaluation, the control unit 23 displays the advertisement being currently displayed on the display unit 240 for a longer time. Accordingly, content displayed on the display unit is displayed for a longer time based on a face image of a viewer viewing the content, so that an interest of the viewer is reflected to increase the advertising effect.

According to the second embodiment, the control unit 23 determines an order of displaying advertisements on the display unit 240 based on an affirmation level of an advertisement displayed on the display unit 240. Accordingly, for example, a viewer can view the advertisements in an order according to his/her interest. The interest of the viewer is reflected to increase the advertising effect.

According to the third embodiment, when an advertisement displayed on the display unit 240 has an affirmation level evaluated to have a predetermined affirmative evaluation, the control unit 23 switches an advertisement being displayed on the display unit 240 to predetermined detailed advertisements relating to the advertisement. Accordingly, an interest of a viewer is reflected to increase the advertising effect. Further, the display system does not require the viewer to select required content, so that the viewer does not have any trouble, and the advertising effect is increased.

According to the fourth embodiment, when an advertisement displayed on the display unit 240 has an affirmation level evaluated to have a predetermined first affirmative evaluation, the control unit 23 switches an advertisement being currently displayed on the display unit 240 to buying information relating to the advertisement. When the advertisement displayed on the display unit 240 has an affirmation level evaluated to have a second affirmative evaluation lower than the first affirmative evaluation, the control unit 23 displays the advertisement being currently displayed on the display unit 240 for a longer time. Accordingly, detailed information relating to content displayed on the display unit 240 is displayed, or the content being displayed is displayed longer, according to a face image of the viewer viewing the content, so that display is performed according to an interest degree of the viewer to increase the advertising effect.

It is noted that the embodiments mentioned above are preferable examples of the display device according to the present invention, but the present invention is not limited to the examples.

In the embodiments mentioned above, the affirmation level is calculated at each time of imaging, and the display time extension processing or the display change processing is performed according to the calculated affirmation level. However, for example, in order to increase the accuracy of the affirmation level, only the affirmation level may be calculated for a few seconds (e.g. three seconds) after switching of the kind of an advertisement displayed on the display unit 240 without performing the display time extension processing or the display change processing.

Further, in the embodiments mentioned above, the expression recognition processing is performed on condition that the line of sight has been recognized. However, the expression recognition processing may be performed regardless of the recognition of the line of sight.

Further, in the embodiments mentioned above, the affirmation level is derived from both of the affirmation level based on expression recognition and the affirmation level based on recognition of the line of sight. However, the affirmation level may be derived only from the affirmation level based on the expression recognition. Alternatively, the affirmation level may be derived only from the affirmation level based on recognition of line of sight.

Further, in the embodiments mentioned above, for determining the affirmation level, a determination method or a determination reference may be changed according to content of an advertisement.

Further, in the embodiments mentioned above, the content of the advertisement displayed on the display unit 240 is changed. However, voice guidance to be output from the sound output unit 33 may be changed, or both of the display and the voice may be changed.

Further, in the embodiments mentioned above, content of an advertisement to be displayed may be adaptively changed, according to a result of determining the affirmation level. The main scenario may be adaptively changed in such a manner that, when the “advertisement A-main” image has an affirmation level larger than the threshold th in the main scenario, an advertisement (e.g. “advertisement E-main” image) of a product similar to a product relating to the “advertisement A-main” image is preferentially displayed, after display relating to the “advertisement A-main” image.

In the embodiments described above, the expression recognition processing and the recognition of line of sight may be performed together with processing for identifying sex or age to obtain information of a person viewing the advertisement. In addition to these pieces of information, marketing information indicating, for example, what kind of person has an interest in what kind of advertisement may be obtained based on the affirmation level or the display time of advertisement calculated in the display time accumulation processing.

Further, in the embodiments mentioned above, the expression recognition or the like is performed based on the picked-up image picked up by the imaging unit 30 to calculate the affirmation level. However, sound recognition may be performed using the sound input unit 34 to calculate the affirmation level, and a method for calculating the affirmation level is not limited to the above-mentioned embodiments.

A computer-readable medium storing a program for performing the above-mentioned processing can employ a non-volatile memory such as a flash memory, and a portable recording medium such as a CD-ROM, in addition to a ROM, a hard disk, and the like. A medium providing program data through a predetermined communication line can also employ a carrier wave.

Furthermore, a detailed configuration and a detailed operation of each unit constituting the display device can be suitably changed within a range not departing from the spirit of the present invention.

The embodiments and modifications of the present invention have been described above, but the spirit and scope of the present invention are not limited to the above-described embodiments and modifications, and the spirit and scope of the invention include the scope of the invention described in the claims and the scope of the equivalents thereof.

The invention described in the scope of the claims originally attached to the application will be attached below. The claim numbers are applied as in the scope of the claims originally attached to the application.

What is claimed is:

1. A display device comprising:
a display unit configured to display an image;
a display control unit configured to switch among a plurality of kinds of content to be displayed on the display unit; and
a content evaluation unit configured to evaluate an affirmation level of content displayed on the display unit,
wherein the display control unit determines content to be displayed on the display unit based on the affirmation level.

2. The display device according to claim 1, further comprising:
an imaging unit configured to pick up an image; and
a face image extraction unit configured to extract a face image of a person from the image picked up by the imaging unit,
wherein the content evaluation unit evaluates, based on the face image, the affirmation level of the content displayed on the display unit.

3. The display device according to claim 2, wherein the content evaluation unit evaluates an expression based on the face image, and evaluates content of a kind displayed on the display unit based on an affirmation level of an expression of the face image.

4. The display device according to claim 3, wherein the content evaluation unit determines which of a plurality of kinds of preset expressions the face image resembles, and evaluates the expression of the face image.

5. The display device according to claim 3, wherein the content evaluation unit derives evaluation values representing an affirmation level of an expression of the face image at predetermined intervals, averages the evaluation values, and evaluates the content of a kind displayed on the display unit based on the averaged evaluation value.

6. The display device according to claim 4, wherein the content evaluation unit derives evaluation values representing an affirmation level of an expression of the face image at predetermined intervals, averages the evaluation values, and evaluates the content of a kind displayed on the display unit based on the averaged evaluation value.

7. The display device according to claim 3, wherein the content evaluation unit detects a line of sight to the display unit based on the face image, and evaluates an expression of the face image on condition that the line of sight has been detected.

8. The display device according to claim 4, wherein the content evaluation unit detects a line of sight to the display unit based on the face image, and evaluates an expression of the face image on condition that the line of sight has been detected.

9. The display device according to claim 5, wherein the content evaluation unit detects a line of sight to the display unit based on the face image, and evaluates an expression of the face image on condition that the line of sight has been detected.

10. The display device according to claim 6, wherein the content evaluation unit detects a line of sight to the display unit based on the face image, and evaluates an expression of the face image on condition that the line of sight has been detected.

11. The display device according to claim 2, wherein the content evaluation unit detects a line of sight to the display unit based on the face image, and evaluates an affirmation level of content of a kind displayed on the display unit based on a result of detecting the line of sight.

12. The display device according to claim 11, wherein the content evaluation unit evaluates an affirmation level of content of a kind displayed on the display unit based on time during which the line of sight to the display unit has been detected.

13. The display device according to claim 1, wherein when the affirmation level evaluated by the content evaluation unit has a predetermined affirmative evaluation, the display control unit displays the content being currently displayed on the display unit for a longer time.

14. The display device according to claim 1, wherein the display control unit determines an order of displaying content to be displayed on the display unit based on the affirmation level.

15. The display device according to claim 1, wherein the display control unit switches content being currently displayed on the display unit to predetermined detailed content relating to the former content, when the affirmation level has a predetermined affirmative evaluation.

16. The display device according to claim 1, wherein when the affirmation level has a predetermined first affirmative evaluation, the display control unit switches the content being currently displayed on the display unit to predetermined detailed content relating to the former content, and when the affirmation level has a second affirmative evaluation lower than the first affirmative evaluation, the display control unit displays the content being currently displayed on the display unit for a longer time.

17. A content display method comprising:
a display control step of switching among a plurality of kinds of content and displaying an image on a display unit configured to display an image;
a content evaluation step of evaluating an affirmation level of content displayed on the display unit; and
a content determination step of determining content to be displayed on the display unit based on the affirmation level.

18. A non-transitory computer-readable storage medium storing a program for causing a computer of a display device, which includes a display unit configured to display an image thereon, to function as:
a display control unit configured to switch among a plurality of kinds of content to be displayed on the display unit;
a content evaluation unit configured to evaluate an affirmation level of content displayed on the display unit; and
a content determination unit configured to determine content to be displayed on the display unit based on the affirmation level.
